(19) United States
(12) Patent Application Publication
(10) Pub. No.: US 2015/0285130 A1
(43) Pub. Date: Oct. 8, 2015

(54) HEAT ENGINE FOR DRIVING A DRIVE SHAFT

(71) Applicant: SOCIETE DE MOTORISATIONS AERONAUTIQUES, Bourges (FR)

(72) Inventors: Guillaume Labedan, Paris (FR); Hugues Denis Joubert, Paris (FR)

(73) Assignee: SOCIETE DE MOTORISATIONS AERONAUTIQUES, Bourges (FR)

(21) Appl. No.: 14/434,604

(22) PCT Filed: Oct. 10, 2013
(86) PCT No.: PCT/FR2013/052428

§ 371 Date: Apr. 9, 2015

(30) Foreign Application Priority Data
Oct. 11, 2012 (FR) 1259726

(51) Int. Cl. F02B 33/40; F02B 39/04; F02B 41/10; F01N 5/04

(52) U.S. Cl. CPC F02B 33/40; F01N 5/04; F02B 39/04; F02B 41/10

(57) ABSTRACT

A heat engine for driving a drive shaft, including at least a gas generator and a turbine, the gas generator supplying the turbine with engine gas and the turbine driving the engine shaft in rotation. The gas generator is a four-stroke internal combustion engine, and includes a compressor for supplying air to the internal combustion engine, the compressor being mechanically driven by the internal combustion engine, and the turbine is mechanically free relative to the internal combustion engine.

### FIELD OF THE INVENTION

This invention relates to a heat engine of the type comprising a gas generator supplying a turbine with engine gas. The turbine is connected to a drive shaft that it drives. The intended application is in particular the propulsion of aircraft in the aeronautical field.

### SUMMARY OF THE PRIOR ART

For driving machines or for the propulsion of vehicles of any kind, a first category of engines comprises open cycle engines that are gas turbine engines. In the aeronautical field, these are in the form of turbojet engines, turbine engines or turboprop engine engines. Another category comprises internal combustion engines such as compression-ignition engines, also known as diesel engines, or spark-ignition engines.

The engines of the second category have specific fuel consumptions that are better than those of the first category. Furthermore, the technology used for the temperatures of the combustion chamber and of the high-pressure turbine make purchasing and maintaining these engine types more expensive.

However, in the aeronautical field in particular, the general application of the engines of the second category for high outputs is limited by the high level of acyclism generated on the output shaft. Said acyclism is harmful for the propellers (in particular for the high-speed narrow propellers) and for the gear trains. Furthermore, for these engines the combustion is also less stable at high altitudes and low temperatures, thus reducing the usable power range.

The specific fuel consumption of the turbine engines and turboprop engines can be improved by optimising the combustion chambers and the yields of the compressors and turbines, or even by way of a regenerative cycle. It cannot however achieve the specific fuel consumptions of the internal combustion engines due to a lower cycle yield. It is impossible to achieve the same combustion pressures as a diesel engine, due to, in particular, the thermal limit of the first turbine stage. Furthermore, the yield of the gas turbines deteriorates rapidly when deviating from the optimal conditions for adapting the compressors and turbines.

The acyclism of piston engines can be treated using dissipation devices that damp torsion or resonators. However, torsional dampers are either heavy and complex, such as DMF-type dissipation dampers used in motor vehicles, with a dedicated lubrication circuit, or they introduce critical rotational speeds, such as resonator dampers of the two-wire pendulum type used in general aviation and for motor racing. In any case, it remains difficult to achieve the low levels of acyclism of gas turbines.

The stability of the combustion of diesel engines at high altitudes can be improved using spark-ignition devices, burners or compressed air supply.

Free-piston engines, the output of which is recovered in a turbine for driving a propeller, have been proposed. Compression and expansion take place on either side of a dual-action piston—two-stroke diesel cycle—which does not therefore transfer any force to a shaft line. Similar solutions have been given for applications pertaining to rail and sea transport. However, the design of the engine is complex. This solution does not make it possible to use modern four-stroke diesel combustion technology. It is also more restrictive thermally due to the two-stroke cycle. It is not very widespread in the industry and is more difficult to control due to the noise generated and its reliability. This invention relates to a heat engine combining the advantages of both categories of engine without the disadvantages thereof.

### SUMMARY OF THE INVENTION

In accordance with the invention, the heat engine for driving a drive shaft, comprising at least a gas generator and a turbine, the gas generator supplying the turbine with engine gas and the turbine setting into rotation the drive shaft, is characterised in that the gas generator is a four-stroke internal combustion engine, in that it comprises a compressor for supplying air to the internal combustion engine, the compressor being driven mechanically by the internal combustion engine, and in that the turbine is mechanically free with respect to the internal combustion engine.

Thus, the solution consists in using a four-stroke engine as a hot gas generator, supplying a free turbine into which the engine output is extracted by an actuator. The work of the internal combustion engine is recovered by the compressor. This free turbine is supplied by the four-stroke engine, in which the high-pressure (HP) expansion and compression phases that are normally carried out in HP compressor and turbine stages in an open cycle engine are carried out. The compression ratio of the gas generator is thus greatly less than that of a conventional internal combustion engine, since the expansion phase does not require too much energy to be extracted from the burned gas in order to supply the free turbine with a gas having sufficient pressure and temperature. It extracts just enough energy to allow the piston to work in the other three cycles: exhaust, intake and compression, and to drive the low-pressure (LP) compressor.

According to an embodiment, the hot gas generator is a diesel engine.

According to another embodiment, the engine comprises, as a gas generator, a spark-ignition internal combustion engine. Said internal combustion engine either replaces the diesel engine or is combined therewith.

Advantageously the compressor is driven by the internal combustion engine via a gearbox and preferably a heat exchanger is arranged between the compressor and the internal combustion engine, or between several stages of the compressor.

The solution of the invention makes it possible to arrange a means for extracting air between the compressor and the internal combustion engine.

In accordance with a variant, a bypass duct is arranged between the compressor and the free turbine. Its object is, for example for a greater output requirement, to increase the gas flow rate and therefore the work available on the turbine, whilst diluting the hot gases coming from the internal combustion engine so as not to exceed the thermal limit of the turbine. It also allows the operating points of the compressor and of the turbine to be adapted to optimise the overall yield.

According to another embodiment made possible by the solution of the invention, an auxiliary combustion chamber is arranged between the exhaust of the internal combustion engine and the free turbine, optionally with a bypass duct of the type mentioned above. An additional compressor may also be provided between the exhaust of the internal combustion engine and the auxiliary combustion chamber.

The auxiliary combustion chamber is thus supplied with a continuous flow of some or all of the gases from the gas generator formed by the internal combustion engine, and optionally by a bypass of the air coming directly from the compressor driven by the internal combustion engine. In the second configuration, this bypass supplies unburned air which allows conditions for the mixing of exhaust gases from the gas generator that are favourable for combustion. This chamber is fitted with one or more fuel injectors and optionally one or more glow plugs for the start-up phases. According to an embodiment allowing the yield to be improved, the fuel is injected in pulses, rather than continuously; the fuel flow can thus be injected in line with the blasts of gas from the exhaust of each cylinder.

The auxiliary combustion chamber can be used during start-up phases to initiate the driving of the compressor. In this case this solution advantageously uses the bypass of the air coming from the compressor to increase the flow and thus the energy available on the turbine, whilst the gas generator is still at a stop or idling, the shaft of the internal combustion engine being driven by a starter, for example an electric or air starter. In this start-up phase, the engine functions as a gas turbine engine. According to an advantageous embodiment, the energy recovered by the actuator driven by the free turbine, is transferred to the start-up system of the gas generator, to allow it to reach the stabilised idle speed. Once this speed has been reached, the injection in the auxiliary combustion chamber can be stopped and the air bypass closed.

Another function of the auxiliary combustion chamber is to optionally provide additional energy at a permanent speed. The combustion of the fuel supplied by the auxiliary injector makes it possible to increase the temperature of the gases coming from the gas generator and thus the energy on the turbine and the actuator, independently of the energy in the gas generator. The bypass of unburned air coming from the compressor may be opened in order to increase the reactivity of the mixture of gas in the auxiliary chamber.

According to another embodiment an additional turbine supplied with some of the exhaust gases from the internal combustion engine is arranged downstream from the exhaust of the internal combustion engine, the shaft of the turbine being mechanically connected to that of the internal combustion engine.

The advantages of the solution of the invention compared with the prior art are, in particular:

Reduced level of vibrations compared with a diesel engine: the solution described allows low torsional vibration to be obtained on the output shaft. The pulsating flow linked to the alternative functioning of the gas generator can be smoothed in a gas manifold.

Stability of the combustion: since the compressor is driven mechanically by the gas generator and is not connected to the output shaft, it is possible to provide the temperature and pressure conditions, whilst avoiding extinction independently of the energy absorbed by the actuator. Furthermore, the combustion is not subject to the constraints relating to the mixture and turbulence of a gas turbine combustion chamber, in particular at a transient speed.

Reduction in fuel consumption compared with an open cycle engine: the improvement is achieved through the driving energy of the compressor. This energy is taken from a, preferably diesel, gas generator, with a better yield due to the high cycle temperatures and pressures. The yield can further be improved by cooling the air after each LP compression stage.

Improved weight:energy ratio: the high level of supercharging allows the cylinder capacity of the gas generator to be reduced, compared with an internal combustion engine of the same power. By contrast, a gear train is desirable for driving the compressor and another between the shaft of the free turbine and the actuator.

Design: there is no aerodynamic coupling or mechanical coupling between the gas generator and the actuator. There are therefore no installation restrictions, with the exception of limiting the pressure drops and the transfer of heat upstream of the free turbine. Air can also be extracted from the LP compressor for services (cabin pressurisation, de-icing) or to adjust the operating point of each stage. The compressor can also be oversized and some of the compressed air extracted to dilute the exhaust gases, in front of the turbine (to increase the gas flow rate whilst reducing the turbine input temperature for example).

Manufacturing costs: for the gas generator the solution does not require an open cycle combustion chamber or a HP turbine, which are the parts of gas turbine engines requiring the most specialised technology due to the high thermal constraints.

In the embodiment with the auxiliary combustion chamber, said auxiliary combustion chamber provides specific advantages for the start-up and boost phases.

For the start-up phases, the start-up of the gas generator with a low compression ratio is facilitated by a supply of compressed air. For this purpose, it is necessary to supply a significant amount of energy to the gas generator so that it can drive the compressor. This energy advantageously comes from the turbine supplied with burned gas via the auxiliary chamber and the bypass of air coming from the compressor. This turbine is therefore comparable to a conventional gas turbine. The energy recovered on the actuator is returned to the air or electric starter of the gas generator. This configuration largely reduces the electrical energy storage requirements.

For boost phases, which are usually required in aircraft for short periods such as during take-off or in the case of an emergency, the supply of power to the turbine by the auxiliary combustion chamber allows the dimensioning of the gas generator to be limited to its rated power. The overall thermal yield is reduced during the boost phases, due to the reduced yield from the auxiliary combustion chamber. But these phases are limited in the duty cycle of the engine. The reduced dimensions of the gas generator provide a reduction in weight and size compared with the same system which would have been dimensioned to allow the boost to be produced without the addition of an auxiliary combustion chamber.

### BRIEF DESCRIPTION OF THE DRAWINGS

The invention will be better understood, and other objects, details, features and advantages thereof will become apparent upon reading the following detailed description of one or more embodiments of the invention, given by way of purely illustrative and non-limiting examples, with reference to the accompanying schematic drawings, in which:

FIG. 1 is a diagram of an installation from the prior art with a free turbine and a gas turbine engine forming the gas generator;

FIG. 2 is a diagram of an installation in accordance with the invention;

FIG. 3 is a diagram of an installation in accordance with the invention, comprising an auxiliary combustion chamber.

### DETAILED DESCRIPTION OF THE INVENTION

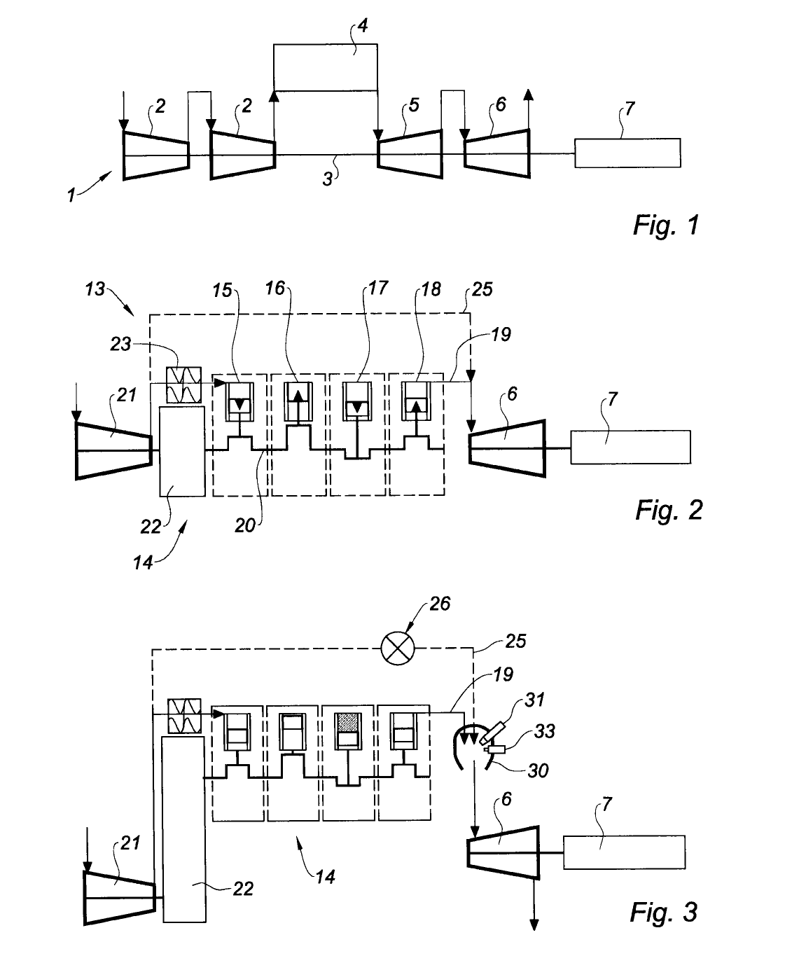

With reference to FIG. 1, the diagram shows a conventional installation 1 with a gas generator 3 and a free turbine 6 driving an actuator 7. The gas generator comprises in the same shaft compressors 2 at several stages, at low and high pressure, supplying an open cycle combustion chamber 4, the combustion gas from which is partially expanded in the turbine 5. This turbine drives the compressors 2 using the common shaft. Having been partially expanded in the turbine 5, the gas is introduced into the free turbine 6, the shaft of which is coupled to that of the actuator 7, which, in the aeronautical field, is generally a propeller. It is noted that the cycle is a constant-pressure combustion cycle in the combustion chamber 4.

In accordance with the invention, a four-stroke internal combustion engine with a gas turbine engine replaces the gas generator.

In FIG. 2, the same free turbine 6 drives the actuator 7.

The gas generator 13 comprises a four-stroke internal combustion engine 14, advantageously a diesel engine. However, said engine could be a spark-ignition engine.

The internal combustion engine 14 conventionally comprises cylinders by means of which the pistons contained therein delimit the combustion chambers. The pistons are fitted to a crankshaft 20, the rotation of which provides the reciprocating movement of the pistons inside the cylinders as well as controlling the intake and exhaust valves for each chamber.

For each of the cylinders, in this case four, 15, 16, 17 and 18, the four stages of the cycle, that is to say, intake, compression, expansion and exhaust, subsequently take place.

The exhaust of the cylinders connects to an exhaust manifold 19 which guides the gas, after leaving the cylinders, into an intake manifold of the gas of the free turbine 6. The gas is expanded in the turbine 6 then expelled, after optionally passing through a regenerator (not shown).

The crankshaft 20 is mechanically connected to a compressor 21 via a gearbox 22 so as to adapt the rotational speed of the compressor 21 to the correct operating speed thereof, which is different to that of the engine 14.

The compressor supplies the cylinders with air at a pressure that is as high as possible, advantageously after said air has been cooled in a suitable heat exchanger 23.

In operation, the air is taken in by the compressor 21, optionally cooled in a heat exchanger 23, let into the cylinders with a suitable fuel, compressed, burned, expanded and expelled into the exhaust manifold 19 then let into the turbine 6. The energy is extracted from the shaft guiding the actuator 7. In accordance with a variant, a bypass duct 25 is arranged between the compressor and the free turbine so as to guide some of the air from the compressor directly towards the free turbine 6 without passing through the internal combustion engine. It makes it possible, for some of the operating phases of the engine, such as a request for additional power, to increase the gas flow rate and thus the work available on the turbine whilst diluting the hot gas from the internal combustion engine so as not to exceed the thermal limit of the turbine. It also makes it possible for the operating points of the compressor and of the turbine to be adapted to optimise the overall yield.

As mentioned above, the compression ratio of the gas generator is here greatly less than that of a conventional engine since the expansion phase is arranged so as to extract just enough energy to allow the work of the piston in the other three stages and to drive the compressor 21. Most of the energy from the burned gas is intended to supply the power turbine 6 with enough pressure and temperature.

In a conventional four-stroke diesel engine the thermal balance is thus established, relative to the available chemical energy:
Energy yielded to the exhaust gas: 45%
Energy dissipated by heat transfer and friction: 15%
Energy available on the output shaft: 40% versus 20 to 30% for an open cycle engine.

Compared with this profile of a “conventional” engine, the gas generator of the installation in FIG. 2 supplies work that is available on the crankshaft that is less by the reduction of the compression ratio. The work available on the shaft is reduced to the amount that is just sufficient to drive the compressor. However, on the one hand, it provides the same maximum combustion pressure thanks to a compressor output pressure that is greater than that of a conventional engine. On the other hand, the energy yielded to the exhaust gas is greater than in a conventional engine and allows the use of the turbine shaft as an engine shaft.

Since the energy is extracted from the turbine, the internal combustion gas engine must have sufficient air flow and pressure, without excessively increasing the cylinder capacity and therefore the mass. This is made possible by a very high-pressure cylinder supply and by reducing the compression ratio. A very high combustion pressure is thus maintained which allows for an optimal yield, with a cylinder capacity that is lower than that of a diesel engine of the same power. The cooling of the air after the compressor also allows the required cylinder capacity to be reduced.

The heat resistance of the combustion chamber must be ensured despite the high rate of compression at the input to the cylinders. It should be noted that the four-stroke cycle is less strict from this point of view, than a two-stroke cycle.

The air can also be cooled after each compression stage, in order to limit the temperature of the cylinders and of the turbine, thus avoiding the use of costly technology.

Cooling also reduces the work required for the compression.

Compared with an open cycle engine, the solution of the invention allows greater expansion ratios in the free turbine, and a lower air:fuel ratio. This allows the air flow and/or the free turbine input temperature to be limited for a given delivered power.

In accordance with a variant shown in FIG. 3, an auxiliary combustion chamber is incorporated between the exhaust of the internal combustion engine and the free turbine.

In FIG. 3 the gas from the internal combustion engine 14 passes into the exhaust manifold 19 and supplies an auxiliary combustion chamber 30 which is fitted with an auxiliary fuel injector 31 and optionally a glow plug 33. The air bypass duct 25 also opens into the auxiliary combustion chamber 30. It can be optionally connected to the exhaust manifold 19. The gas from the combustion chamber is then guided towards the free turbine 6.

The fuel injection in the auxiliary combustion chamber 30 is controlled according to the operating phase or mode of the engine. The auxiliary combustion chamber gas thus either comes from the cylinders, the bypass 25 or partially from each circuit. The gas flow rates of each circuit are controlled by suitable valves. The duct 25 is for example fitted with a valve 26 controlling the bypass of the air coming from the compressor 21.

A start-up operating mode is for example as follows. The internal combustion engine 14 is driven by a starter (not shown), supplied with electrical or pneumatic energy as the case may be. It drives the compressor which supplies the auxiliary combustion chamber. The gas produced drives the turbine which supplies, by means of the actuator 7 and a suitable arrangement, additional energy to the starter. Said starter can then drive the internal combustion engine with sufficient power to start it up suitably.

According to other embodiments which are not shown,
a compressor is incorporated between the exhaust of the internal combustion engine and the combustion chamber, or
an additional turbine is supplied with some of the exhaust gases from the internal combustion engine, the shaft of the additional turbine being linked mechanically to the shaft of the internal combustion engine.

1-10. (canceled)

11: A heat engine for driving an engine shaft, comprising:
a gas generator; and
a turbine, the gas generator supplying the turbine with engine gas and the turbine setting into rotation the engine shaft,
wherein the gas generator is a four-stroke internal combustion engine comprising an exhaust;
wherein the turbine is mechanically free with respect to the internal combustion engine; and
the heat engine further comprising:
a compressor for supplying air to the internal combustion engine, the compressor being driven mechanically by the internal combustion engine;
means for extracting air between the compressor and the internal combustion engine;
a bypass duct between the compressor and the free turbine;
the turbine is mechanically free with respect to the internal combustion engine; and
an auxiliary combustion chamber between the exhaust of the internal combustion engine and the free turbine.

12: An engine according to claim 11, wherein the auxiliary combustion chamber comprises at least an auxiliary fuel injector configured to inject a flow of fuel that is controlled according to an operating mode or phase of the engine, and means to control flow of gas passing through the internal combustion engine and in the bypass duct.

13: An engine according to claim 11, further comprising an electrical machine, or a starter, configured to drive the internal combustion engine and to, itself, be supplied with energy by the turbine.

14: An engine according to claim 11, wherein the internal combustion engine is a diesel engine.

15: An engine according to claim 11, wherein the internal combustion engine is a spark-ignition engine.

16: An engine according to claim 11, wherein the compressor is driven by the internal combustion engine via a gearbox.

17: An engine according to claim 11, further comprising a heat exchanger between the compressor and the internal combustion engine.

18: An engine according to claim 17, further comprising a compressor between an exhaust of the internal combustion engine and the auxiliary combustion chamber.

19: An engine according to claim 11, further comprising an additional turbine supplied with some of exhaust gas from the internal combustion engine, a shaft of the additional turbine being mechanically connected to that of the internal combustion engine.
